(19) United States
(12) Patent Application Publication
(10) Pub. No.: US 2017/0293170 A1
(43) Pub. Date: Oct. 12, 2017

(54) ELECTRO-OPTIC DEVICE, ELECTRONIC DEVICE, AND MANUFACTURING METHOD FOR ELECTRO-OPTIC DEVICE

(71) Applicant: SEIKO EPSON CORPORATION, Tokyo (JP)

(72) Inventors: Daisuke MIYAWAKI, Chitose-shi (JP); Toshiki TANI, Sapporo-shi (JP); Hiroyuki OIKAWA, Sakata-shi (JP)

(73) Assignee: SEIKO EPSON CORPORATION, Tokyo (JP)

(21) Appl. No.: 15/481,938

(22) Filed: Apr. 7, 2017

(30) Foreign Application Priority Data
Apr. 12, 2016 (JP) 2016-079360

(51) Int. Cl. G02F 1/1339; G03B 21/00; G02F 1/1343

(52) U.S. Cl. CPC G02F 1/1339; G02F 1/134309; G02F 1/13394; G03B 21/006; G02F 2201/123

(57) ABSTRACT

An electro-optic device includes an element substrate including a plurality of pixel electrodes on one surface of the element substrate, an opposite substrate opposing the one surface of the element substrate via an electro-optic layer, and a seal material configured to bond the element substrate to the opposite substrate. The seal material includes a plurality of gap materials that controls a substrate-to-substrate distance between the element substrate and the opposite substrate. A concave portion is formed in the opposite substrate within a region surrounded by the seal material, and is configured to allow the substrate-to-substrate distance in a display region to be broader than the substrate-to-substrate distance in a region overlapping with the seal material.

### BACKGROUND

### 1. Technical Field

The present invention relates to an electro-optic device including an element substrate and an opposite substrate that are bonded to each other by a seal material, an electronic device including the electro-optic device, and a manufacturing method for the electro-optic device.

### 2. Related Art

A liquid crystal device that is a typical electro-optic device includes an element substrate 10, an opposite substrate 20, and a seal material 80, as schematically shown in FIG. 12. The element substrate 10 includes a plurality of pixel electrodes 9a on one surface 10s of the element substrate 10 itself. The opposite substrate 20 is disposed opposing the one surface 10s of the element substrate 10 via an electro-optic layer 50. A common electrode 21 is formed on the opposing substrate 20. The seal material 80 is configured to bond the element substrate 10 to the opposite substrate 20. Further, the seal material 80 includes an adhesive agent portion 82 and a plurality of gap materials 81. The gap materials 81 are dispersed in the adhesive agent portion 82, and each of the gap materials 81 has a bead-like shape or a fiber-like shape. With this configuration, when the substrate-to-substrate distance between the element substrate 10 and the opposite substrate 20 is denoted by G0, this substrate-to-substrate distance G0 is controlled by the gap materials 81, and the thickness of the electro-optic layer 50 is controlled by the substrate-to-substrate G0.

Meanwhile, a technology that optimizes the thickness of the electro-optic layer 50 has been disclosed, and in this technology, there is proposed a structure in which, as shown in FIG. 13, a step difference portion 20h (a concave portion) is disposed in the opposite substrate 20 so as to allow a substrate-to-substrate distance G2 in a region overlapping with the seal material 80 to be broader than a substrate-to-substrate distance G1 in a region surrounded by the seal material 80. According to this technology, the thickness of the electro-optic layer 50 is kept thin without reducing the external diameter of each of the gap materials (see JP-A-2011-203289).

In such a structure as shown in FIG. 13, however, water is likely to invade the inside from the outside via the seal material 80 because the thickness of the seal material 80 becomes thick. As a result, there is a disadvantage in that, not only the deterioration of the electro-optic layer 50, but also the deterioration of each of the pixel electrodes 9a and the common electrode 21, is likely to occur.

### SUMMARY

An advantage of some aspects of the invention is that an electro-optic device that enables not only the optimization of the thickness of the electro-optic layer, but also the reduction of the invasion of water via the seal material, an electronic device including such an electro-optic device, and a manufacturing method for such an electro-optic device are provided.

According to a first aspect of the invention, an electro-optic device includes an element substrate including a plurality of pixel electrodes on one surface of the element substrate, an opposite substrate opposing the one surface of the element substrate via an electro-optic layer, a seal material including a plurality of gap materials that controls a substrate-to-substrate distance between the element substrate and the opposite substrate, the seal material being configured to bond the element substrate to the opposite substrate, and a concave portion formed in one of the element substrate and the opposite substrate within a region surrounded by the seal material, the concave portion being configured to allow the substrate-to-substrate distance in a display region to be broader than the substrate-to-substrate distance in a region overlapping with the seal material.

According to the first aspect of the invention, in the above electro-optic device, the concave portion is disposed in one of the element substrate and the opposite substrate so as to allow the substrate-to-substrate distance in the display region to be broader than the substrate-to-substrate distance in the region overlapping with the seal material. With this configuration, the adjustment of the depth of the concave portion enables the optimization of the substrate-to-substrate distance in the display region (the thickness of the electro-optic layer). Further, even when the substrate-to-substrate distance in the display region has been optimized, this optimization does not change the substrate-to-substrate distance in the region overlapping with the seal material, and thus, no change is needed in the seal material. Further, even when the substrate-to-substrate distance in the display region has been optimized, the substrate-to-substrate distance in the region overlapping with the seal material remains narrow, and thus, the thickness of the seal material is kept thin. This configuration, therefore, enables reduction of the invasion of water via the seal material.

In the first aspect of the invention, a configuration in which at least one substrate-to-substrate conducting material including a plurality of conductive particles and an adhesive agent portion is disposed at a position located outside the seal material and located between the element substrate and the opposite substrate may be employed. With this configuration, there is a merit in that no change is needed in the size of each of the conductive particles of the at least one substrate-to-substrate conducting material.

In the first aspect of the invention, a configuration in which the concave portion is disposed in the opposite substrate may be employed. This configuration eliminates, unlike a configuration in which the concave portion is disposed in the element substrate, the occurrence of a failure caused by step differences due to the concave portion, such as disconnection of a wiring or any other interconnection disposed on the element substrate.

In the first aspect of the invention, a configuration in which the concave portion is constituted by a hole including a bottom portion and formed in a substrate body of the opposite substrate may be employed.

In the first aspect of the invention, a configuration in which the opposite substrate includes a substrate body and a light transmissive film disposed on an element-substrate-side surface of the substrate body, and the concave portion is constituted by a hole formed in the light transmissive film may be employed.

In this case, a configuration in which the light transmissive film includes a first light transmissive film and a second light transmissive film disposed at an element-substrate side of the first light transmissive film, the hole penetrates the second light transmissive film, and an etching stopper layer is disposed between the first light transmissive film and the second light transmissive film in a region outside the hole may be employed.

In the first aspect of the invention, a configuration in which the seal material is seamlessly formed in an entire peripheral portion of the electro-optic device may be employed.

In the first aspect of the invention, a configuration in which the electro-optic layer is a liquid crystal layer may be employed.

According to a second aspect of the invention, in a manufacturing method for an electro-optic device including an element substrate including a plurality of pixel electrodes on one surface of the element substrate, an opposite substrate opposing the one surface of the element substrate via an electro-optic layer, and a seal material including a plurality of gap materials that controls a substrate-to-substrate distance between the element substrate and the opposite substrate, the seal material being configured to bond the element substrate to the opposite substrate, the manufacturing method includes forming a concave portion by etching in one of the element substrate and the opposite substrate within a region surrounded by the seal material, so as to allow the substrate-to-substrate distance in a display region to be broader than the substrate-to-substrate distance in a region overlapping with the seal material.

In the second aspect of the invention, a method in which, when the concave portion is formed, after a first light transmissive film, an etching stopper layer, and a second light transmissive film have been stacked one on another on a substrate body, the second light transmissive film is etched to form the concave portion in a state in which an etching mask is formed on a surface of the second light transmissive film until the etching reaches the etching stopper layer, and then the etching stopper layer is removed from a bottom portion of the concave portion may be employed. Through this method, the thicknesses of the second light transmissive film and the etching stopper layer enable the control of the depth of the concave portion.

The electro-optic device according to the first aspect of the invention is capable of being used in various electronic devices. Here, when a projection type display device is configured as one of such electronic devices, the projection type display device includes the electro-optic device according to the first aspect of the invention, a light source portion configured to supply light to the electro-optic device, and a projection optical system configured to project light having been optically modulated by the electro-optic device. Further, the electro-optic device to which the invention is applied is capable of being used to configure a display portion in electronic devices, such as a mobile telephone and a mobile computer.

### BRIEF DESCRIPTION OF THE DRAWINGS

The invention will be described with reference to the accompanying drawings, wherein like numbers reference like elements.

FIG. 1 is a plan view of an electro-optic device according to embodiment 1 of the invention illustrating one configuration of the electro-optic device.

FIG. 2 is a cross-sectional view of the electro-optic device illustrated in FIG. 1 taken along the line II-II of FIG. 1.

FIG. 3 is a schematically enlarged cross-sectional view of the electro-optic device illustrated in FIG. 1.

FIG. 4 is a schematically enlarged cross-sectional view of the electro-optic device illustrated in FIG. 1 in the case where the thickness of an electro-optic layer of the electro-optic device illustrated in FIG. 1 has been changed.

FIG. 5 is a diagram illustrating a manufacturing method for an electro-optic device according to embodiment 1 of the invention, and illustrates step cross-sectional views of the electro-optic device.

FIG. 6 is a diagram illustrating the relationship between the thickness of a seal material and the result of high temperature and high humidity test in an electro-optic device.

FIG. 7 is a schematically enlarged cross-sectional view of an electro-optic device according to embodiment 2 of the invention.

FIG. 8 is a diagram illustrating a manufacturing method for the electro-optic device illustrated in FIG. 7, and illustrates step cross-sectional views of the electro-optic device.

FIG. 9 is a schematically enlarged cross-sectional view of an electro-optic device according to embodiment 3 of the invention.

FIG. 10 is a diagram illustrating a manufacturing method for the electro-optic device illustrated in FIG. 9, and illustrates step cross-sectional views of the electro-optic device.

FIG. 11 is a diagram illustrating an outline configuration of a projection type display device (electronic device) using an electro-optic device to which the invention is applied.

FIG. 12 is a diagram illustrating an electro-optic device according to a comparison example of the invention.

FIG. 13 is a diagram illustrating an electro-optic device according to another comparison example of the invention.

### DESCRIPTION OF EXEMPLARY EMBODIMENTS

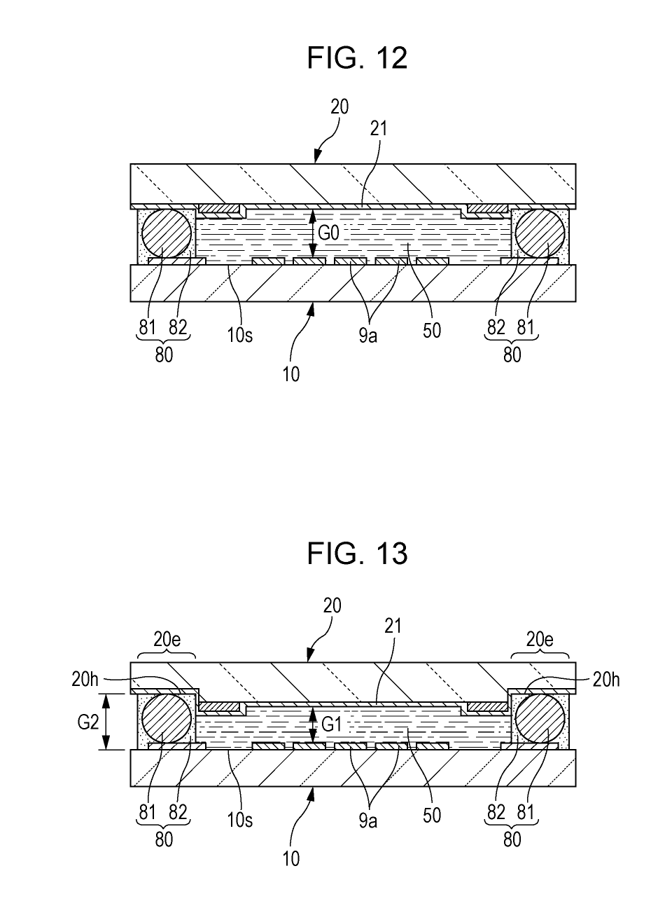

Embodiments according to the invention will be described with reference to the drawings. In figures to be referred to in the following description, the reduced scales of layers and members are made different for each of the layers and each of the members so as to allow the layers and the members to have recognizable degree of sizes on the figures. Further, in order to make it easy to understand the correspondence relationship with the configuration having already been described with reference to FIGS. 12 and 13, the following description will be made so as to allow members corresponding to the members included in the already described configuration to be denoted by reference sings identical to those of the members included in the already described configuration.

### Embodiment 1

### Overall Configuration

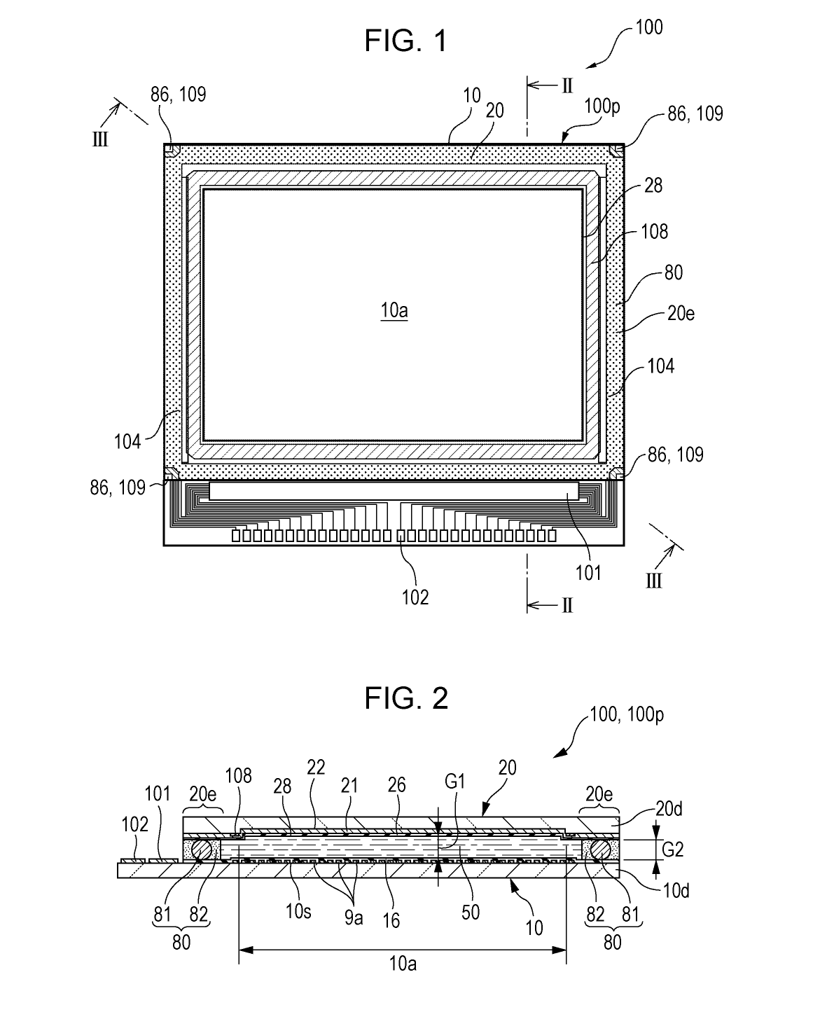

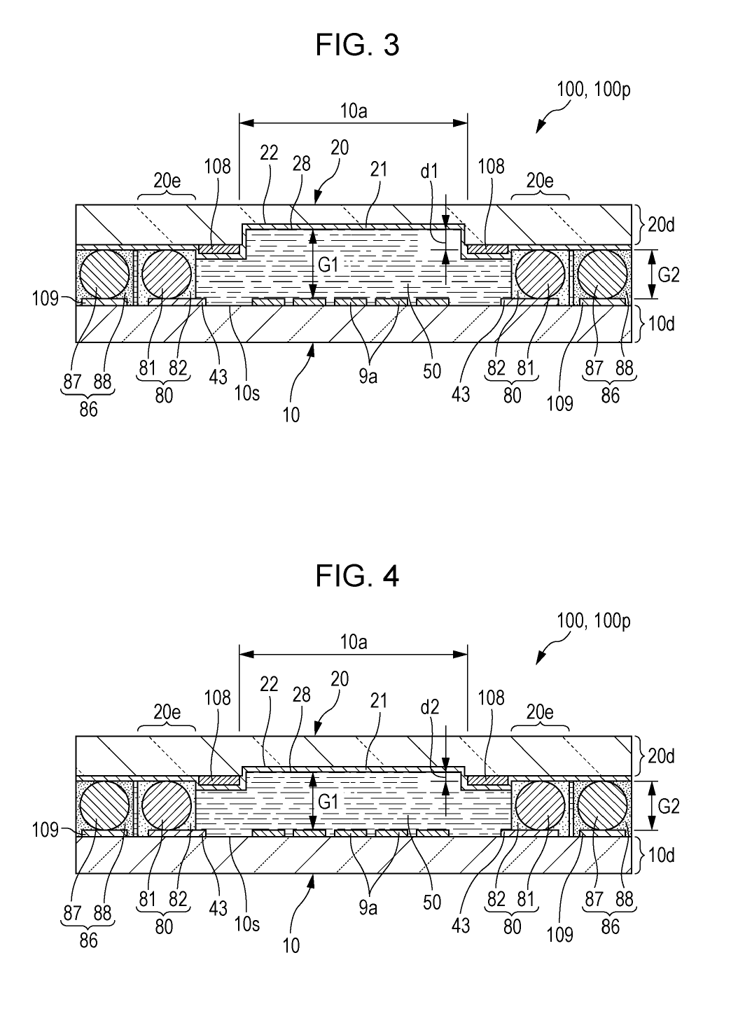

FIG. 1 is a plan view of an electro-optic device 100, an electro-optic device according to embodiment 1 of the invention, illustrating one configuration of the electro-optic device 100. In FIG. 1, the statuses of individual constituent elements of the electro-optic device 100 when viewed from the side of an opposite substrate 20 are illustrated. FIG. 2 is a cross-sectional view of the electro-optic device 100 illustrated in FIG. 1 taken along the line II-II of FIG. 1. FIG. 3 is a diagram illustrating a schematically enlarged cross-sectional view of the electro-optic device 100 illustrated in FIG. 1, and corresponds to a cross sectional view of the electro-optic device 100 taken along the line III-III of FIG. 1. It should be noted that, in FIG. 3, with respect to the element substrate 10, only pixel electrodes 9a, substrate-to-substrate conducting electrodes 109, and films existing in a region overlapping with a seal material 80, such as a layer-to-layer insulating film 43, are illustrated, and with respect to the opposite substrate 20, only a common electrode 21 is illustrated. Further, although a plurality of gap materials 81 exist in the width direction of the seal material 80, only one of the gap materials 81, contained in the seal material 80, is illustrated in each of FIGS. 2 and 3.

As shown in FIGS. 1 and 2, the electro-optic device 100 includes a liquid crystal panel 100p. The liquid crystal panel 100p includes the element substrate 10, the opposite substrate 20, and the seal material 80. The element substrate 10 includes the plurality of pixel electrodes 9a on the one surface 10s of the element substrate 10 itself. The opposite substrate 20 is disposed opposing the one surface 10s of the element substrate 10 via the electro-optic layer 50. The seal material 80 is configured to bond the element substrate 10 to the opposite substrate 20. In the element substrate 10, an alignment film 16 is formed on the upper layer side (on the opposite-substrate 20 side) of the pixel electrodes 9a. The alignment film 16 is made of a resign film, such as a polyimide resin film, or an obliquely evaporated film, such as a silicon dioxide film. The common electrode 21 is formed on the opposite substrate 20, and an alignment film 26 is formed on the upper layer side (on the element-substrate 10 side) of the common electrode 21. The alignment film 26 is made of a resign film, such as a polyimide resin film, or an obliquely evaporated film, such as a silicon dioxide film.

The seal material 80 is annularly disposed so as to be along the peripheral edge of the opposite substrate 20. The seal material 80 includes the adhesive agent portion 82. The adhesive agent portion 82 includes the gap materials 81, and each of the gap materials 81 has a bead-like shape or a fiber-like shape. The gap materials 81 are dispersed inside the adhesive agent portion 82, and control the substrate-to-substrate distance between the element substrate 10 and the opposite substrate 20.

In the electro-optic device 100, the electro-optic layer 50 is retained between the element substrate 10 and the opposite substrate 20 within a region surrounded by the seal material 80, and is constituted of a liquid crystal layer. In this embodiment, when the electro-optic layer 50 is provided, a one-drop-fill method (ODF method) in which a display region is filled with drops of liquid crystal is employed. In such a method, for example, the seal material 80 is disposed on the element-substrate 10 side, and then the drops of an electro-optic material in a liquid condition are caused to fall inside the seal material 80. Thereafter, the element substrate 10 and the opposite substrate 20 are bonded to each other. With this configuration, the seal material 80 is seamlessly formed in the entire peripheral portion. Here, a method in which the element substrate 10 is bonded to the opposite substrate 20 in a state in which one portion of the seal material 80 is broken, and then, an electro-optic material in a liquid condition is injected from the broken portion of the seal material 80 by means of a vacuum injection method may be employed. In this case, finally, the broken portion of the seal material 80 is sealed using a sealing material.

A substrate body 10d and a substrate body 20d are respectively used in the element substrate 10 and the opposite substrate 20. The substrate body 10d is, for example, a quartz substrate or a glass substrate, and similarly to the substrate body 10d, the substrate body 20d is a quartz substrate or a glass substrate. Here, when the electro-optic device 100 is configured as a reflection type, one substrate body that is the substrate body 10d or the substrate body 20d, whichever is the incident side of external light, is required to have a light transmission property, whereas the other substrate body is not required to have the light transmission property. In contrast thereto, when the electro-optic device 100 is configured as a transmission type, both of the substrate body 10d and the substrate body 20d are required to have a light transmission property.

In the opposite substrate 20, a parting portion 108 is formed on one surface of the substrate body 20d so as to extend along the inner edge of the seal material 80. The parting portion 108 has a light-blocking property, and a region inside the parting portion 108 is a display region 10a. Further, there is also a case where a material having a light blocking property and constituting the parting portion 108 is disposed as a black matrix at each of positions facing the portions between every two adjacent ones of the pixel electrodes 9a. In the element substrate 10, a data line drive circuit 101 and a plurality of terminals 102 are formed on one surface of the substrate body 10d in a region outside the display region 10a so as to be along one side of the element substrate 10, and a scanning line drive circuit 104 is formed along each of other sides adjacent to the one side of the element substrate 10. Further, in addition to the pixel electrodes 9a, pixel transistors, wirings, and any other components that are electrically coupled to the respective pixel electrodes 9a are formed on the one surface of the substrate body 10d. Further, the common electrode 21 is formed on one surface of the substrate body 20d. Further, a substrate-to-substrate conducting material 86 is formed at each of at least one of the corner portions of the opposite substrate 20 so as to allow the substrate-to substrate conducting electrode 109 of the element substrate 10 and the common electrode 21 of the opposite substrate 20 to be electrically conducted to each other at the outside of the seal material 80.

In the present embodiment, the electro-optic device 100 is a transmission type liquid crystal device, and each of the pixel electrodes 9a and the common electrode 21 is formed of a conductive film having a light transmission property, such as an indium tin oxide (ITO) film or an indium zinc oxide (IZO) film. In such a liquid crystal device of a transmission type (the electro-optic device 100), for example, light having been entered from the opposite substrate 20 is optically modulated so as to display an image during a period until the light is output from the element substrate 10. Further, when the electro-optic device 100 is a liquid crystal device of a reflection type, the common electrode 21 is formed of a conductive film having a light transmission property, such as an ITO film or an IZO film, and each of the pixel electrodes 9a is formed of a conductive film having a light reflection property, such as an aluminum film. In such a liquid crystal device of a reflection type (the electro-optic device 100), light having been entered from the opposite substrate 20 is optically modulated so as to display an image during a period until the light is reflected by the element substrate 10 and is output.

The electro-optic device 100 is capable of being used as a color display device of an electronic device, such as a mobile computer or a mobile telephone, and in this case, a color filter (not illustrated) or a protection film is formed at the side of the opposite substrate 20. Further, the electro-optic device 100 is capable of being used as a light valve for each of RGB colors in a projection type display device (a liquid crystal projector) described later. In this case, light rays corresponding to each of RGB colors and having been resolved through dichroic mirrors for resolving the RGB colors enter a corresponding one of the electro-optic devices 100 for the RGB colors as projection light rays, and thus, no color filter is formed.

### Control of Thickness of Electro-Optic Layer 50

FIG. 4 is a schematically enlarged cross-sectional view of the electro-optic device 100 shown in FIG. 1 when the thickness of the electro-optic layer 50 has been changed, and FIG. 4 corresponds to FIG. 3. In the electro-optic device 100 shown in FIGS. 2 and 3, the thickness of the electro-optic layer 50 is required to be optimized for the purpose of optimization and any other adjustment of retardation and any other property. In the present embodiment, in order to deal with such a requirement, a concave portion 28 is formed in one of the element substrate 10 and the opposite substrate 20 within a region surrounded by the seal material 80. This concave portion 28 is formed so as to, without changing the kind of the seal material 80 (i.e., without changing the size of each of the gap materials 81), allow the substrate-to-substrate distance G1, which is a substrate-to-substrate distance in the display region 10a within the region surrounded by the seal material 80, to be broader than the substrate-to-substrate distance G2, which is a substrate-to-substrate distance in a region 20e, a region overlapping with the seal material 80.

In this embodiment, the concave portion 28 is formed in the opposite substrate 20 among the element substrate 10 and the opposite substrate 20, and the bottom portion of the concave portion 28 is a flat face. The concave portion 28 is constituted by a hole 22, and this hole 22 is a hole having a bottom portion and resulting from engraving a portion included in the substrate body 20d and having a constant thickness by means of a wet etching method, a dry etching method, or any other method. With this configuration, in the substrate body 20d, a region in which the hole 22 is formed has a thin thickness.

Further, in the opposite substrate 20, the common electrode 21 is formed on the whole of the opposite substrate 20. With this configuration, the common electrode 21 is continuously formed from the inside (the bottom portion) of the concave portion 28 to the outside of the concave portion 28. Further, on the opposite substrate 20, the parting portion 108 is formed in a region outside the concave portion 28. In this regard, however, with respect to the parting portion 108, the parting portion 108 may be formed inside the concave portion 28 (at the bottom portion of the concave portion 28). Further, the side faces of the concave portion 28 are preferred to be taper faces, and this configuration reduces the occurrence of disconnection of the common electrode 21 due to step differences of the concave portion 28.

Further, the substrate-to-substrate conducting material 86 is disposed at a position located outside the seal material 80 and located between the element substrate 10 and the opposite substrate 20. The substrate-to-substrate conducting material 86 includes conductive particles 87 and an adhesive agent portion 88, and allows the substrate-to-substrate conducting electrode 109, formed on the element substrate 10, and the common electrode 21, formed on the facing electrode 20, to be electrically conducted to each other. Each of the conductive particles 87 includes a layer made of metal, such as gold or silver, on the surface of a plastic bead or any other similar material. With this configuration, the substrate-to-substrate conducting electrode 109 is capable of supplying a common electric potential to the common electrode 21 via the substrate-to-substrate conducting material 86.

Here, in the configuration shown in FIG. 3, the depth of the concave portion 28 is denoted by d1. In this case, the substrate-to-substrate distance G1 in the display region 10a (the thickness of the electro-optic layer 50) is equal to the sum of the depth d1 of the concave portion 28 and the substrate-to-substrate distance G2 in the region 20e overlapping with the seal material 80. Meanwhile, when, as shown in FIG. 4, the depth of the concave portion 28 is denoted by d2 (d1>d2), the substrate-to-substrate distance G1 in the display region 10a (the thickness of the electro-optic layer 50) is equal to the sum of the depth d2 of the concave portion 28 and the substrate-to-substrate distance G2 in the region 20e overlapping with the seal material 80. Accordingly, when the substrate-to-substrate distance G1 in the display region 10a (the thickness of the electro-optic layer 50) is adjusted to an optimum value, the change of the substrate-to-substrate distance G2 in the region 20e overlapping with the seal material 80 is not needed, and the change of the depth of the concave portion 28 is simply needed.

### Manufacturing Method

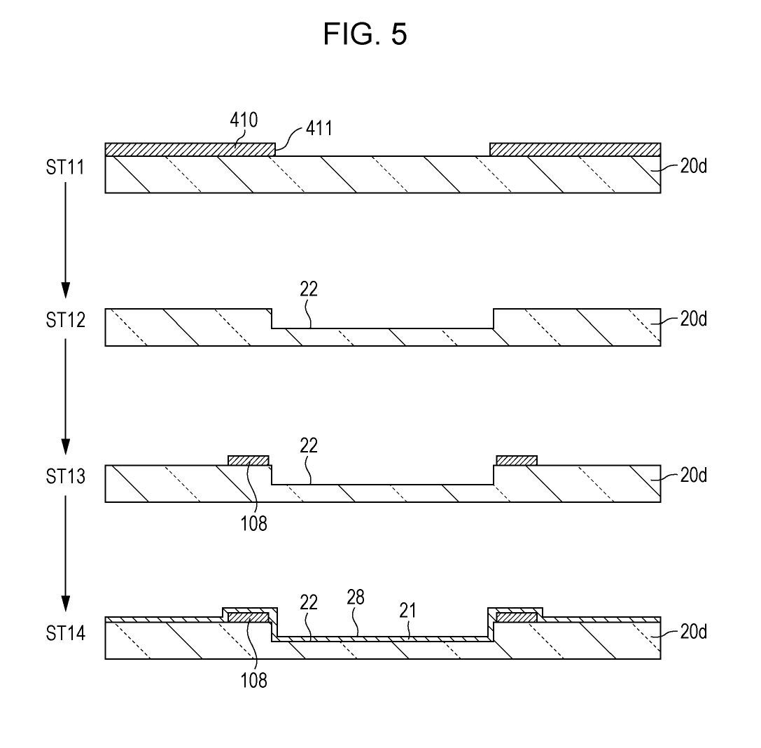

FIG. 5 is a diagram illustrating a manufacturing method for the electro-optic device 100 according to embodiment 1 of the invention, and illustrates step cross-sectional views of the electro-optic device 100 in individual steps of forming the concave portion 28 in the opposite substrate 20 among manufacturing steps for the electro-optic device 100. In the present embodiment, first, in step ST11 shown in FIG. 5, an etching mask 410 is formed on the substrate body 20d of the opposite substrate 20. The edging mask 410 includes an opening portion 411, and this opening portion 411 corresponds to a region including the display region 10a. Next, in step ST12 shown in FIG. 5, etching is performed from the opening portion 411 into the substrate body 20d to form the hole 22, and then, the etching mask 410 is removed. Next, in step ST13 shown in FIG. 5, the parting portion 108 is formed on the opposite substrate 20, and then, in step ST14 shown in FIG. 5, the common electrode 21 is formed. As a result, in the common electrode 21, the concave portion 28 in which the hole 22 is reflected is formed. Here, the parting portion 108 may be formed on the substrate body 20d in any one of a region outside the concave portion 28 and a region inside the concave portion 28 (a region at the side of the bottom portion of the concave portion 28). Further, in step ST14 shown in FIG. 5, the common electrode 21 may be formed after a protection film (not illustrated), such as a silicon dioxide film, has been formed.

### Main Effects of the Present Embodiment

As described above, the concave portion 28 is formed in the opposite substrate 20 of the electro-optic device 100 to allow the substrate-to-substrate distance G1 in the display region 10a to be broader than the substrate-to-substrate distance G2 in the region 20e overlapping with the seal material 80. With this configuration, the adjustment of the depth of the concave portion 28 enables the optimization of the substrate-to-substrate distance G1 in the display region 10a (the thickness of the electro-optic layer 50).

Further, even when the substrate-to-substrate distance G1 in the region 10a has been optimized, this optimization does not change the substrate-to-substrate distance G2 in the region 20e overlapping with the seal material 80, and thus, no change is needed in the seal material 80. Further, even when the substrate-to-substrate distance G1 in the region 10a has been optimized, the substrate-to-substrate distance G2 in the region overlapping with the seal material 80 remains narrow, and thus, the thickness of the seal material 80 is kept thin. This configuration, therefore, reduces the invasion of water via the seal material 80.

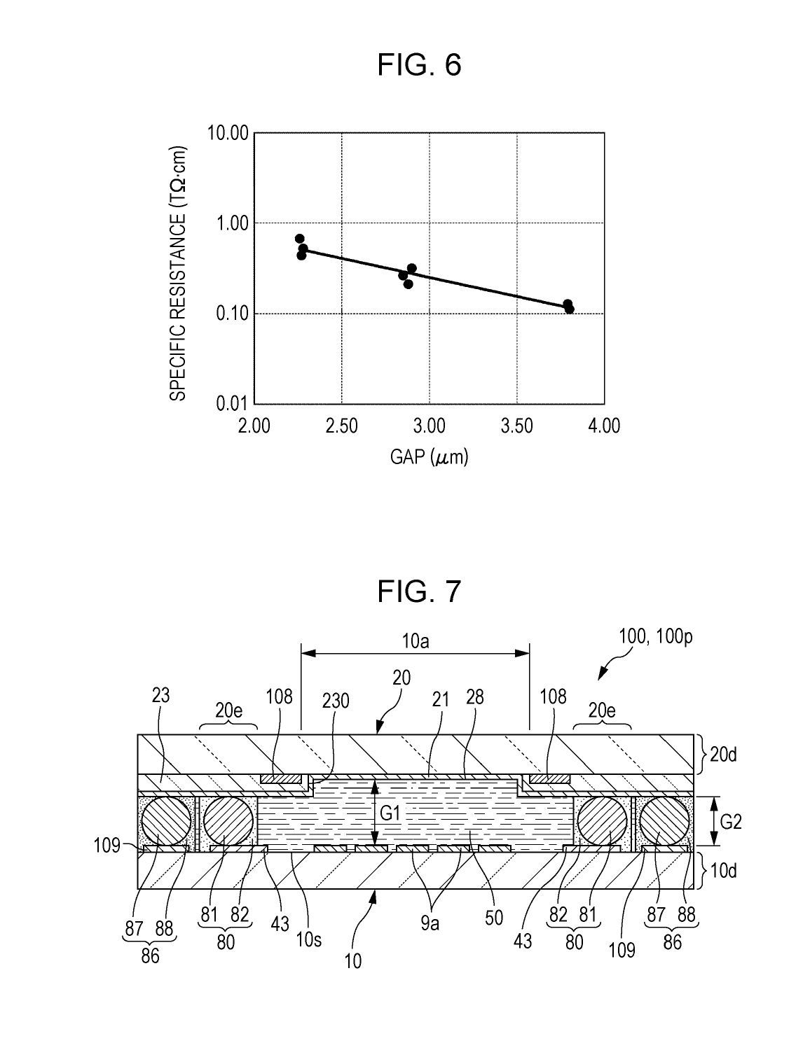

FIG. 6 is a diagram illustrating the relationship between the thickness of the seal material 80 and the result of high temperature and high humidity test in the electro-optic device 100. In order to consider the relationship between the thickness of the seal material 80 and the invasion of water via the seal material 80, a plurality of liquid crystal panels 100p were produced so as to cause the substrate-to-substrate distance G2 in the region overlapping with the seal material 80 in each of the liquid crystal panels 100p to be different from that in any other one of the liquid crystal panels 100p, and the specific resistance of the ITO film of each of the liquid crystal panels 100p was investigated after the liquid crystal panels 100p had been left untouched for 72 hours under a circumstance condition of a temperature of 85° C. and a humidity of 85%. The result of the high temperature and high humidity test is illustrated in FIG. 6. As understood from FIG. 6, there is a tendency in that, the narrower the substrate-to-substrate distance G2 in the region overlapping with the seal material 80 is, the smaller the deterioration of the ITO film (the reduction of the specific resistance due to moisture absorption) is. That is, it can be said that, the narrower the substrate-to-substrate distance G2 in the region overlapping with the seal material 80 is, the thinner the thickness of the seal material 80 is, and thus, the amount of water invaded via the seal material 80 becomes small.

Further, in the present embodiment, the substrate-to-substrate conducting material 86, which includes the conductive particles 87 and the adhesive agent portion 88, is disposed at a position located outside the seal material 80 and located between the element substrate 10 and the opposite substrate 20. With this configuration, there is a merit in that even when the substrate-to-substrate distance G1 in the display region 10a has been optimized, no change of the size of each of the conductive particles 87 of the substrate-to-substrate conducting material 86 is needed.

Further, in the present embodiment, the concave portion 28 is disposed in the opposite substrate 20. This configuration, therefore, unlike a configuration in which the concave portion is disposed in the element substrate 10, eliminates the occurrence of a failure caused by step differences due to the concave portion, such as disconnection of a wiring or any other interconnection disposed on the element substrate 10.

### Embodiment 2

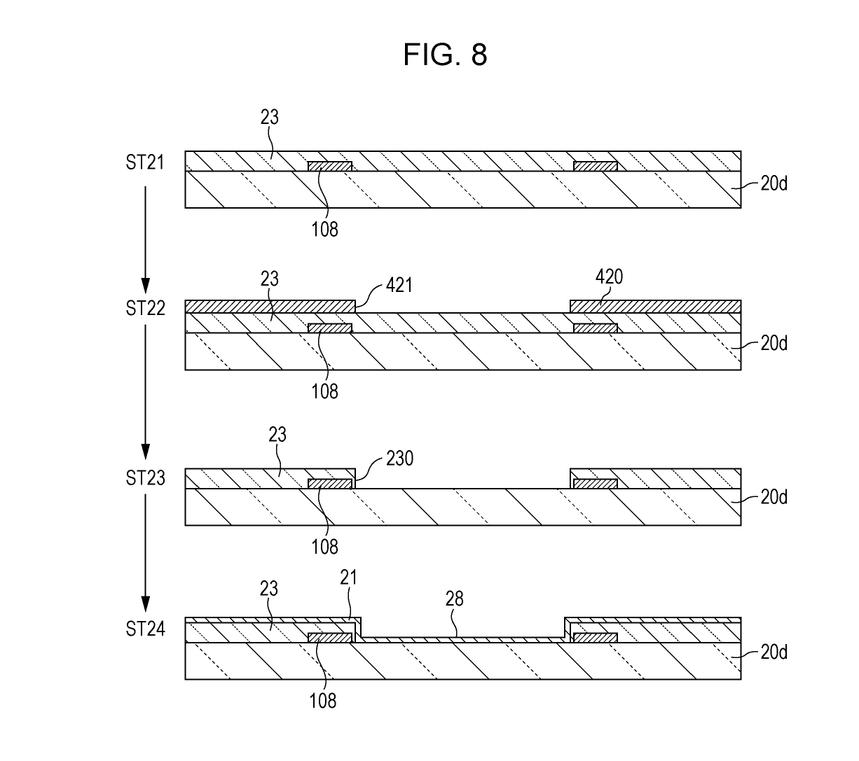

FIG. 7 is a schematically enlarged cross-sectional view of an electro-optic device 100, an electro-optic device according to embodiment 2 of the invention, and FIG. 7 corresponds to FIG. 3. FIG. 8 is a diagram illustrating a manufacturing method for the electro-optic device 100 shown in FIG. 7, and illustrates step cross-sectional views of the electro-optic device 100 in individual steps of forming the concave portion 28 in the opposite substrate 20 among manufacturing steps for the electro-optic device 100. Here, the fundamental configuration of the present embodiment is the same as that of embodiment 1, and thus, portions of the present embodiment that are similar to portions of embodiment 1 are denoted by reference signs identical to those of the portions of embodiment 1, and description of such portions of the present embodiment will be omitted below.

As shown in FIG. 7, in the electro-optic device 100 according to the present embodiment, similarly to embodiment 1, the concave portion 28 is formed in the opposite substrate 20 so as to allow the substrate-to-substrate distance G1 in the display region 10a to be broader than the substrate-to-substrate distance G2 in the region 20e overlapping with the seal material 80. Here, a light transmissive film 23 is formed on the element substrate 10 side surface of the substrate body 20d of the opposite substrate 20, and the light transmissive film 23 is formed of a silicon dioxide film or any other similar film. Further, a hole 230 is formed in the light transmissive film 23, and this hole 230 constitutes the concave portion 28. In the present embodiment, the hole 230 penetrates the light transmissive film 23. With this configuration, the concave portion 28 having a depth corresponding to the thickness of the light transmissive film 23 is formed in the opposite substrate 20.

In the present embodiment, similarly, the common electrode 21 is continuously formed from the inside (the bottom portion) of the concave portion 28 to the outside of the concave portion 28. Further, for the opposite substrate 20, the parting portion 108 is formed between the substrate body 20d and the light transmissive film 23 in a region outside the concave portion 28. Further, the substrate-to-substrate conducting material 86 is disposed at a position located outside the seal material 80 and located between the element substrate 10 and the opposite substrate 20. Here, the parting portion 108 may be formed on the opposite side surface of the light transmissive film 23 from the substrate body 20d (i.e., between the light transmissive film 23 and the common electrode 21).

In the present embodiment, in order to form the concave portion 28 in the opposite substrate 20, in step ST21 shown in FIG. 8, the parting portion 108 is formed on the substrate body 20d of the opposite substrate 20, and then, the light transmissive film 23, which is formed of a silicon dioxide film or any other similar film, is formed. Next, in step ST22 shown in FIG. 8, an etching mask 420 is formed on the light transmissive film 23. The edging mask 420 includes an opening portion 421, and this opening portion 421 corresponds to a region including the display region 10a. Next, in step ST23 shown in FIG. 8, etching is performed from the opening portion 421 into the light transmissive film 23 to form the hole 230, and then, the etching mask 420 is removed. Next, in step ST24 shown in FIG. 8, the common electrode 21 is formed. Here, in step ST24 shown in FIG. 8, the common electrode 21 may be formed after a protection film (not illustrated), such as a silicon dioxide film, has been formed.

As described above, similarly to embodiment 1, the concave portion 28 is formed in the opposite substrate 20 of the electro-optic device 100 so as to allow the substrate-to-substrate distance G1 in the display region 10a to be broader than the substrate-to-substrate distance G2 in the region 20e overlapping with the seal material 80. With this configuration, the adjustment of the depth of the concave portion 28 enables the optimization of the substrate-to-substrate distance G1 in the display region 10a (the thickness of the electro-optic layer 50). Further, even when the substrate-to-substrate distance G1 in the region 10a has been optimized, this optimization does not change the substrate-to-substrate distance G2 in the region 20e overlapping with the seal material 80, and thus, no change is needed in the seal material 80. Further, even when the substrate-to-substrate distance G1 in the region 10a has been optimized, the substrate-to-substrate distance G2 in the region overlapping with the seal material 80 remains narrow, and thus, the thickness of the seal material 80 is kept thin. With this configuration, therefore, the same effects as those of embodiment 1, such as the reduction of the invasion of water via the seal material 80, are brought about. Further, in the present invention, since the concave portion 23 is constituted by the hole 230, which penetrates the light transmissive film 23, the adjustment of the thickness of the light transmissive film 23 enables the control of the depth of the concave portion 28, and thus, the control of the depth of the concave portion 28 is facilitated. Further, in order to change the substrate-to-substrate distance G1 in the display region 10a (the thickness of the electro-optic layer 50), the change of the thickness of the light transmissive film 23 is simply needed. Further, in the present embodiment, the light transmissive film 23, which is disposed in a region overlapping with the seal material 80, has a light transmission property, and thus, the light transmissive film 23 is unlikely to become an obstacle when the seal material 80 is optically hardened.

Here, although the hole 230 penetrates the light transmissive film 23 in the present embodiment, the hole 230 may be formed up to an intermediate position in the thickness direction of the light transmissive film 23.

### Embodiment 3

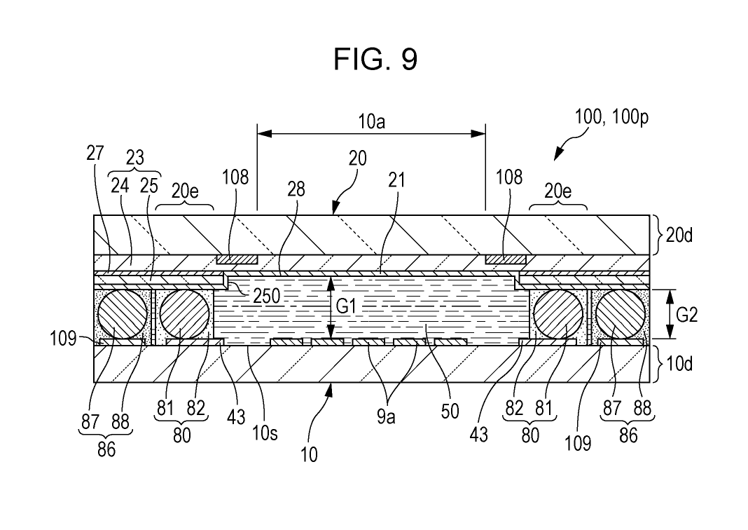

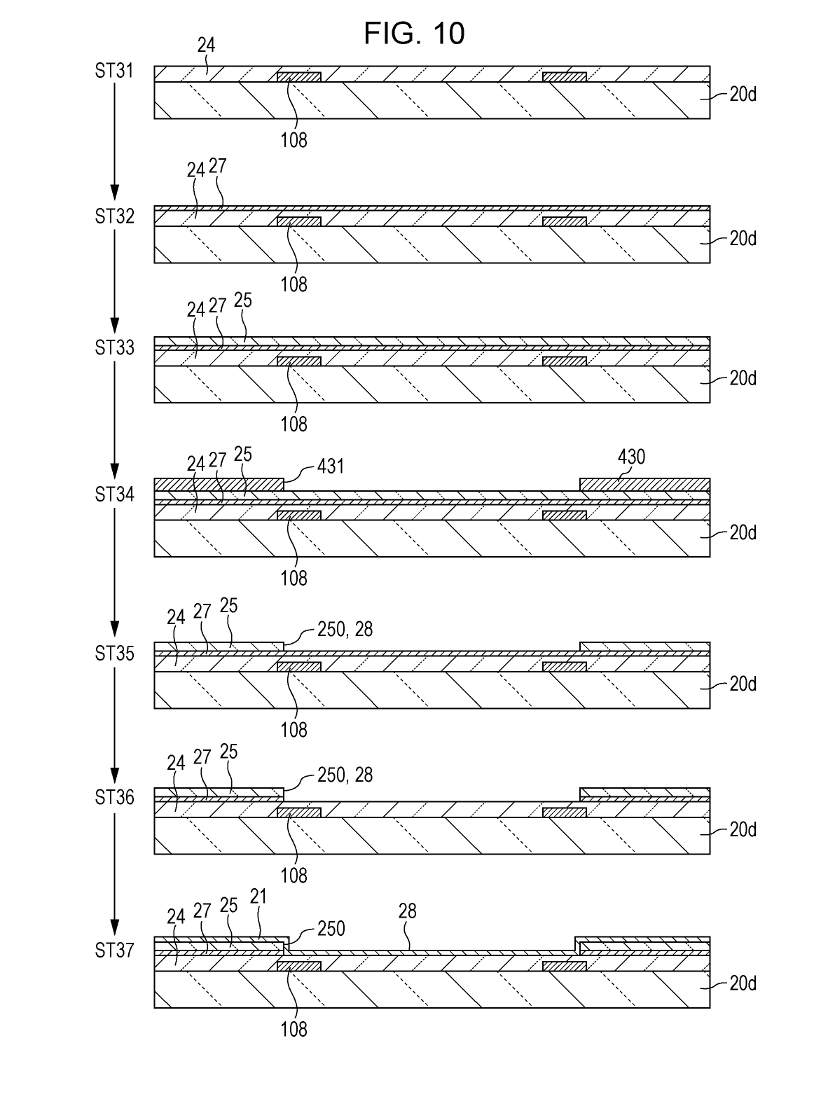

FIG. 9 is a schematically enlarged cross-sectional view of an electro-optic device 100, an electro-optic device according to embodiment 3 of the invention, and FIG. 9 corresponds to FIG. 3. FIG. 10 is a diagram illustrating a manufacturing method for the electro-optic device 100 shown in FIG. 9, and illustrates step cross-sectional views of the electro-optic device 100 in individual steps of forming the concave portion 28 in the opposite substrate 20 among manufacturing steps for the electro-optic device 100. Here, the fundamental configuration of the present embodiment is the same as that of embodiment 1, and thus, portions of the present embodiment that are similar to portions of embodiment 1 are denoted by reference signs identical to those of the portions of embodiment 1, and description of such portions of the present embodiment will be omitted below.

As shown in FIG. 9, in the electro-optic device 100 according to the present embodiment, similarly to embodiment 1, the concave portion 28 is formed in the opposite substrate 20 so as to allow the substrate-to-substrate distance G1 in the display region 10a to be broader than the substrate-to-substrate distance G2 in the region 20e overlapping with the seal material 80. In the present embodiment, similarly to embodiment 2, the light transmissive film 23, which is formed of a silicon dioxide film or any other similar film, is formed on the element substrate 10 side surface of the substrate body 20d of the opposite substrate 20, and the concave portion 28 is constituted by a hole formed in the light transmissive film 23.

In the present embodiment, the light transmissive film 23 includes a first light transmissive film 24 and a second light transmissive film 25. The second light transmissive film 25 is disposed at the element substrate 10 side of the first light transmissive film 24. Further, a hole 250 is formed in the second light transmissive film 25 so as to penetrate the second light transmissive film 25. With this configuration, the concave portion 28 is constituted by the hole 250, which is formed in the second light transmissive film 25. Further, in a region outside the hole 250, an etching stopper layer 27 is disposed between the first light transmissive film 24 and the second light transmissive film 25. The etching stopper layer 27 is formed of a silicon film or any other similar film.

In the present embodiment, similarly, the common electrode 21 is continuously formed from the inside (the bottom portion) of the concave portion 28 to the outside of the concave portion 28. Further, for the opposite substrate 20, the parting portion 108 is formed between the substrate body 20d and the first light transmissive film 24 in a region outside the concave portion 28.

In the present embodiment, in order to form the concave portion 28 in the opposite substrate 20, in step ST31 shown in FIG. 10, the parting portion 108 is formed on the substrate body 20d of the opposite substrate 20, and then, the first light transmissive film 24, which is formed of a silicon dioxide film or any other similar film, is formed. Next, in step ST32 shown in FIG. 10, the etching stopper layer 27 is formed on the upper layer of the first light transmissive film 24. The etching stopper layer 27 has a light transmission property, and is formed of an ITO film or any other similar film. Next, in step ST33 shown in FIG. 10, the second light transmissive film 25 is formed on the upper layer of the etching stopper layer 27. The second light transmissive film 25 is formed of a silicon dioxide film or any other similar film.

Next, in step ST34 shown in FIG. 10, an etching mask 430 is formed on the second light transmissive film 25. The edging mask 430 includes an opening portion 431, and this opening portion 431 corresponds to a region including the display region 10a. Next, in step ST35 shown in FIG. 10, wet etching is performed from the opening portion 431 into the second light transmissive film 25 to form a hole 250 (the concave portion 28), and then, the etching mask 430 is removed. Next, in step ST36 shown in FIG. 10, the etching stopper layer 27, which is exposed on the bottom portion of the hole 250 (the bottom portion of the concave portion 28), is removed by wet etching.

Next, in step ST37 shown in FIG. 10, the common electrode 21 is formed. In this case, in step ST37 shown in FIG. 10, the common electrode 21 may be formed after a protection film (not illustrated) formed of a silicon dioxide film or any other similar film has been formed.

According to such a manufacturing method as described above, the depth the concave portion 28 is defined by the thicknesses of the second light transmissive film 25 and the etching stopper layer 27 when the second light transmissive film 25 and the etching stopper layer 27 have been formed. Thus, the depth of the concave portion 28 is capable of being controlled with a high accuracy. Further, in order to change the substrate-to-substrate distance G1 in the display region 10a (the thickness of the electro-optic layer 50), the change of the thickness of the second light transmissive film 25 is simply needed.

As described above, similarly to embodiment 1, the concave portion 28 is formed in the opposite substrate 20 of the electro-optic device 100 so as to allow the substrate-to-substrate distance G1 in the display region 10a to be broader than the substrate-to-substrate distance G2 in the region 20e overlapping with the seal material 80. With this configuration, the adjustment of the depth of the concave portion 28 enables the optimization of the substrate-to-substrate distance G1 in the display region 10a (the thickness of the electro-optic layer 50). Further, even when the substrate-to-substrate distance G1 in the region 10a has been optimized, this optimization does not change the substrate-to-substrate distance G2 in the region 20e overlapping with the seal material 80, and thus, no change is needed in the seal material 80. Further, even when the substrate-to-substrate distance G1 in the region 10a has been optimized, the substrate-to-substrate distance G2 in the region overlapping with the seal material 80 remains narrow, and thus, the thickness of the seal material 80 is kept thin. With this configuration, therefore, the same effects as those of embodiment 1, such as the reduction of the invasion of water via the seal material 80, are brought about. Further, in the present invention, the first light transmissive film 24, the etching stopper layer 27, and the second light transmissive film 25 remain in the region overlapping with the seal material 80, but each of these layers has a light transmission property, and thus is unlikely to become an obstacle when the seal material 80 is optically hardened.

### Other Embodiments

Although, in the above embodiments, the concave portion 28 is formed in the opposite substrate 20, the concave portion 28 may be formed in the element substrate 10.

Although, in the above embodiments, the liquid crystal device is exemplified as the electro-optic device 100, the invention may be applied to other electro-optic devices, such as an electrophoretic display device and an organic electroluminescent device.

### Example of Mounting in Electronic Device

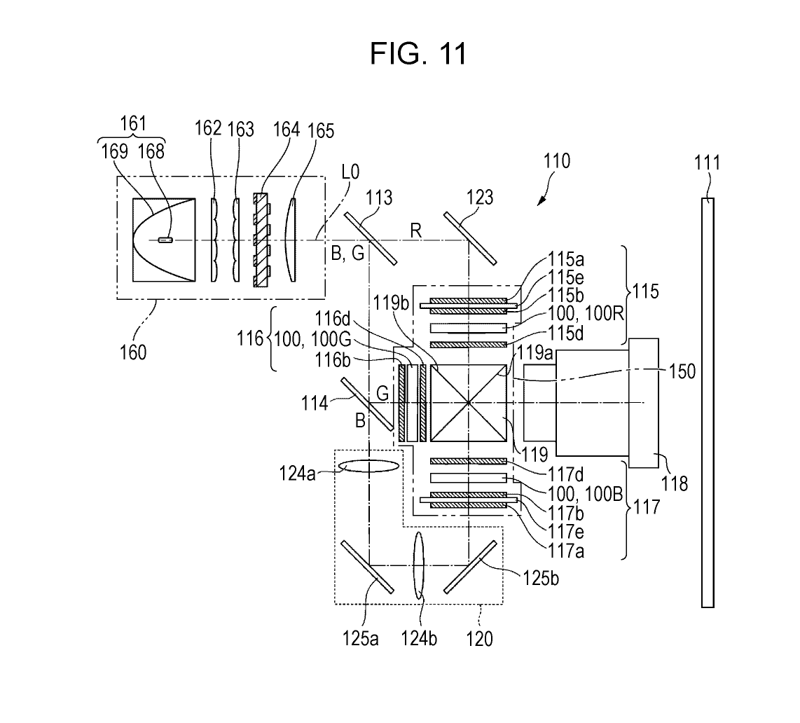

FIG. 11 is a diagram illustrating an outline configuration of a projection type display device (an electronic device) using the electro-optic device 100 to which the invention has been applied. Here, in the following description, although a plurality of electro-optic devices 100 are used and light rays having mutually different wavelength ranges are supplied to the respective electro-optic devices 100, the electro-optic devices 100 to which the invention has been applied is used in any one of the plurality of electro-optic devices 100.

FIG. 11 illustrates a projection type display device 110, and this projection type display device 110 is a liquid crystal projector using a plurality of transmission type electro-optic devices 100, and irradiates a projected member 111 with light lays to display an image thereon. This projected member 111 is composed of a screen and any other member. The projection type display device 110 includes, along a device light axis L0, an illumination device 160, the plurality of electro-optic devices 100 (liquid crystal light valves 115 to 117), a cross-dichroic prism 119 (a light combining optical system), and a projection optical system 118. Light rays emitted from the illumination device 160 are supplied to the plurality of electro-optic devices 100 (the liquid crystal light valves 115 to 117). Light rays emitted from the plurality of electro-optic devices 100 (the liquid crystal light valves 115 to 117) are combined and emitted by the cross-dichroic prism 119. Further, light rays having been combined by the cross-dichroic prism 119 are projected by the projection optical system 118. Further, the projection type display device 110 includes dichroic mirrors 113 and 114, and a relay system 120. In the projection type display device 110, the electro-optic devices 100 and the cross-dichroic prism 119 constitute an optical unit 150.

In the illumination device 160, a light source portion 161, a first integrator lens 162, a second integrator lens 163, a polarization changing element 164, and a condenser lens 165 are disposed in this order along the device optical axis L0. The first integrator lens 162 is constituted by a lens array, such as a fly-eye lens. The second integrator lens 163 is also constituted by a lens array, such as a fly-eye lens. The light source portion 161 includes a light source 168 and a reflector 169. This light source 168 emits white light rays including red light rays R, green light rays G, and blue light rays B. The light source 168 is constituted by a super-high pressure mercury lamp or any other similar lamp, and the reflector 169 has a parabolic curved cross-sectional face. Each of the first integrator lens 162 and the second integrator lens 163 uniforms the illumination distribution of the light rays emitted from the light source portion 161. The polarization changing element 164 changes the light rays emitted from the light source portion 161 into polarized light having a specific oscillation direction, such as s-polarized light.

The dichroic mirror 113 allows the red light rays R, which are included in the light rays having been emitted from the illumination device 160, to be transmitted through the dichroic mirror 113 itself, and reflects the green light rays G and the blue light rays B, these two kinds of light rays being also included in the light rays having been emitted from the illumination device 160. The dichroic mirror 114 allows the blue light rays B to be transmitted through the dichroic mirror 114 itself, and reflects the green light rays G, among the blue light rays B and the green light rays G, which have been reflected by the dichromatic mirror 113. In this way, the dichromatic mirrors 113 and 114 constitute a color separation optical system that separates the light rays having been emitted from the illumination device 160 into the red light rays R, the green light rays G, and the blue light rays B.

The liquid crystal light valve 115 is the transmission type electro-optic device 100, and this transmission type electro-optic device 100 modulates, in accordance with an image signal, the red light rays R having been transmitted through the dichroic mirror 113 and having been reflected by a reflection mirror 123. The liquid crystal light valve 115 includes a λ/2 phase difference plate 115a, a first polarization plate 115b, the electro-optic device 100 (a red color electro-optic device 100R), and a second polarization plate 115d. Here, with respect to the red light rays R to be input to the liquid crystal light valve 115, the polarization of the red light rays is not changed even after the red light rays R have been transmitted through the dichroic mirror 113, and thus, the red light rays R remain the s-polarized light.

The λ/2 phase difference plate 115a is an optical element that converts the s-polarized light having been input to the liquid crystal valve 115 into p-polarized light. The first polarization plate 115b is a polarization plate that blocks the s-polarized light and allows the p-polarized light to be transmitted through the first polarization plate 115b itself. The electro-optic device 100 (the red color electro-optic device 100R) is configured to convert the p-polarized light into the s-polarized light (circularly-polarized light or elliptically-polarized light in the case of a halftone image) by modulation in accordance with the image signal. The second polarization plate 115d is a polarization plate that blocks the p-polarized light and allows the s-polarized light to be transmitted through the second polarization plate 115d itself. Accordingly, the liquid crystal valve 115 modulates the red light rays R in accordance with the image signal, and emits the modulated red light rays R toward the cross-dichroic prism 119. The λ/2 phase difference plate 115a and the first polarization plate 115b are disposed in a state of being in contact with a glass plate 115e. This glass plate 115e has a light transmission property that does not allow the polarized light to be converted, and enables the reduction of distortion of each of the λ/2 phase difference plate 115a and the first polarization plate 115b due to generated heat.

The liquid crystal light valve 116 is the transmission type electro-optic device 100, and this transmission type electro-optic device 100 modulates, in accordance with the image signal, the green light rays G having been reflected by the dichroic mirror 113 and then having been reflected by the dichroic mirror 114. The liquid crystal light valve 116 includes, similarly to the liquid crystal valve 115, a first polarization plate 116b, the electro-optic device 100 (a green color electro-optic device 100G), and a second polarization plate 116d. The green light rays G to be input to the liquid crystal valve 116 is s-polarized light having been reflected by the dichroic mirrors 113 and 114 and then being input thereto. The first polarization plate 116b is a polarization plate that blocks the p-polarized light and allows the s-polarized light to be transmitted through the first polarization plate 116b itself. The electro-optic device 100 (the green color electro-optic device 100G) is configured to convert the s-polarized light into the p-polarized light (circularly-polarized light or elliptically-polarized light in the case of a halftone image) by modulation in accordance with the image signal. The second polarization plate 116d is a polarization plate that blocks the s-polarized light and allows the p-polarized light to be transmitted through the second polarization plate 116d itself. Accordingly, the liquid crystal valve 116 modulates the green light rays G in accordance with the image signal, and emits the modulated green light rays G toward the cross-dichroic prism 119.

The liquid crystal light valve 117 is the transmission type electro-optic device 100, and this transmission type electro-optic device 100 modulates the blue light rays B having been reflected by the dichroic mirror 113, having been transmitted through the dichroic mirror 114, and then having been passed through the relay system 120. The liquid crystal light valve 117 includes, similarly to the liquid crystal valves 115 and 116, a λ/2 phase difference plate 117a, a first polarization plate 117b, the electro-optic device 100 (a blue color electro-optic device 100B), and a second polarization plate 117d. The blue light rays B to be input to the liquid crystal light valve 117 is s-polarized light because the blue light rays are reflected by two reflection mirrors 125a and 125b of the relay system 120 after having been reflected by the dichroic mirror 113 and having been transmitted through the dichroic mirror 114.

The λ/2 phase difference plate 117a is an optical element that converts the s-polarized light having been input to the liquid crystal valve 117 into p-polarized light. The first polarization plate 117b is a polarization plate that blocks the s-polarized light and allows the p-polarized light to be transmitted through the first polarization plate 117b itself. The electro-optic device 100 (the blue color electro-optic device 100B) is configured to convert the p-polarized light into the s-polarized light (circularly-polarized light or elliptically-polarized light in the case of a halftone image) by modulation in accordance with the image signal. The second polarization plate 117d is a polarization plate that blocks the p-polarized light and allows the s-polarized light to be transmitted through the second polarization plate 117d itself. Accordingly, the liquid crystal valve 117 modulates the blue light rays B in accordance with the image signal, and emits the modulated blue light rays B toward the cross-dichroic prism 119. Here, the λ/2 phase difference plate 117a and the first polarization plate 117b are disposed in a state of being in contact with a glass plate 117e.

The relay system 120 includes relay lenses 124a and 124b and reflection mirrors 125a and 125b. The relay lenses 124a and 124b are disposed to reduce the light loss of the blue light rays B due to the long length of the light path for the blue light rays B. The relay lens 124a is disposed between the dichroic mirror 114 and the reflection mirror 125a. The relay lens 124b is disposed between the reflection mirrors 125a and 125b. The reflection mirror 125a reflects the blue light rays B having been transmitted through the dichroic mirror 114 and having been emitted from the relay lens 124a, toward the relay lens 124b. The reflection mirror 125b reflects the blue light rays B having been emitted from the relay lens 124b, toward the liquid crystal light valve 117.

The cross dichroic prism 119 is a color combining optical system in which two dichroic films 119a and 119b are orthogonally disposed in an X-shape. The dichroic film 119a is a film that reflects the blue light rays B and allows the green light rays G to be transmitted through the dichroic film 119a itself, and the dichroic film 119b is a film that reflects the red light rays R and allows the green light rays G to be transmitted through the dichroic film 119b itself. Accordingly, the cross-dichroic prism 119 combines the red light rays R, the green light rays G, and the blue light rays B, which have been respectively modulated by the liquid crystal valve 115, the liquid crystal valve 116, and the liquid crystal valve 117, and then emits the combined light rays toward the projection optical system 118.

Here, each of the two kinds of light rays to be input to the cross-dichroic prism 119 from the liquid crystal light valves 115 and 117 is the s-polarized light, and the light rays to be input to the cross-dichroic prism 119 from the liquid crystal light valve 116 is the p-polarized light. In this way, the three kinds of light rays to be input to the cross-dichroic prism 119 are made different kinds of polarized light, and thus, this configuration enables the three kinds of light rays input from the respective liquid crystal light valves 115 to 117 to be combined in the cross-dichroic prism 119. Here, in general, the dichroic films 119a and 119b are superior in the reflection property of the s-polarized light. For this reason, the red light rays R and the blue light rays B, which are respectively reflected by the dichroic film 119b and the dichroic film 119a, are made the s-polarized light, and the green light rays G, which are transmitted through the dichroic films 119a and 119b, is made the p-polarized light. The projection optical system 118 includes a projection lens (omitted from illustration), and project the light rays having been combined by the cross-dichroic prism 119 onto the projected member 111, such as a screen. Other Projection type Display Devices

The above projection type display device may be configured such that an LED light source that emits individual kinds of color light rays is employed as the light source portion and each of the individual kinds of color light rays having been emitted from the LED light source is supplied to a corresponding one of mutually different electro-optic devices.

The electro-optic device 100 to which the invention is applied may be applied to, not only the above electronic device, but also electronic devices, such as a projection type head-up display (HUD), a direct-view type head mount display (HMD), a mobile telephone, an information mobile terminal (a personal digital assistant (PDA)), a digital camera, a liquid crystal television set, a car navigation device, and a videophone.

The entire disclosure of Japanese Patent Application No. 2016-079360, filed Apr. 12, 2016 is expressly incorporated by reference herein.

What is claimed is:

1. An electro-optic device comprising:
an element substrate including a plurality of pixel electrodes on one surface of the element substrate;
an opposite substrate opposing the one surface of the element substrate via an electro-optic layer;
a seal material including a plurality of gap materials that controls a substrate-to-substrate distance between the element substrate and the opposite substrate, the seal material being configured to bond the element substrate to the opposite substrate, and
a concave portion formed in one of the element substrate and the opposite substrate within a region surrounded by the seal material, the concave portion being configured to allow the substrate-to-substrate distance in a display region to be broader than the substrate-to-substrate distance in a region overlapping with the seal material.

2. The electro-optic device according to claim 1, wherein at least one substrate-to-substrate conducting material including a plurality of conductive particles and an adhesive agent portion is disposed at a position located outside the seal material and located between the element substrate and the opposite substrate.

3. The electro-optic device according to claim 1, wherein the concave portion is disposed in the opposite substrate.

4. The electro-optic device according to claim 1, wherein the concave portion is constituted by a hole including a bottom portion and formed in a substrate body of the opposite substrate.

5. The electro-optic device according to claim 1,
wherein the opposite substrate includes a substrate body and a light transmissive film disposed on an element-substrate-side surface of the substrate body, and
wherein the concave portion is constituted by a hole formed in the light transmissive film.

6. The electro-optic device according to claim 5,
wherein the light transmissive film includes a first light transmissive film and a second light transmissive film disposed at an element-substrate-side of the first light transmissive film,
wherein the hole penetrates the second light transmissive film, and
wherein an etching stopper layer is disposed between the first light transmissive film and the second light transmissive film in a region outside the hole.

7. The electro-optic device according to claim 1, wherein the seal material is seamlessly formed in an entire peripheral portion of the electro-optic device.

8. The electro-optic device according to claim 1, wherein the electro-optic layer is a liquid crystal layer.

9. An electronic device comprising the electro-optic device according to claim 1.

10. An electronic device comprising the electro-optic device according to claim 2.

11. An electronic device comprising the electro-optic device according to claim 3.

12. An electronic device comprising the electro-optic device according to claim 4.

13. An electronic device comprising the electro-optic device according to claim 5.

14. An electronic device comprising the electro-optic device according to claim 6.

15. An electronic device comprising the electro-optic device according to claim 7.

16. An electronic device comprising the electro-optic device according to claim 8.

17. The electronic device according to claim 9 further comprising a light source portion configured to supply light to the electro-optic device, and a projection optical system configured to project light having been optically modulated by the electro-optic device.

18. The electronic device according to claim 10 further comprising a light source portion configured to supply light to the electro-optic device, and a projection optical system configured to project light having been optically modulated by the electro-optic device.

19. A manufacturing method for an electro-optic device including an element substrate including a plurality of pixel electrodes on one surface of the element substrate, an opposite substrate opposing the one surface of the element substrate via an electro-optic layer, and a seal material including a plurality of gap materials that controls a substrate-to-substrate distance between the element substrate and the opposite substrate, the seal material being configured to bond the element substrate to the opposite substrate, the manufacturing method comprising forming a concave portion by performing etching on one of the element substrate and the opposite substrate within a region surrounded by the seal material, so as to allow the substrate-to-substrate distance in a display region to be broader than the substrate-to-substrate distance in a region overlapping with the seal material.

20. The manufacturing method according to claim 19, wherein, when the concave portion is formed, after a first light transmissive film, an etching stopper layer, and a second light transmissive film have been stacked one on another on a substrate body, in order to form the concave portion, etching is performed on the second light transmissive film in a state in which an etching mask is formed on a surface of the second light transmissive film until the etching reaches the etching stopper layer, and then the etching stopper layer is removed from a bottom portion of the concave portion.
